(19) United States
(12) Patent Application Publication
(10) Pub. No.: US 2022/0388301 A1
(43) Pub. Date: Dec. 8, 2022

(54) FLUIDIC DIE CHANGE OF DIRECTION DETECTION

(71) Applicant: Hewlett-Packard Development Company, L.P., Spring, TX (US)

(72) Inventors: Daryl Eugene Anderson, Corvallis, OR (US); James Michael Gardner, Corvallis, OR (US)

(73) Assignee: Hewlett-Packard Development Company, L.P., Spring, TX (US)

(21) Appl. No.: 17/775,350

(22) PCT Filed: Nov. 15, 2019
(86) PCT No.: PCT/US2019/061592

§ 371 Date: May 9, 2022

(51) Int. Cl. B41J 2/045

(52) U.S. Cl. CPC B41J 2/04508; B41J 2/04581; B41J 2/0458

(57) ABSTRACT

In some examples, a controller to receives, from a strain sensor in a fluidic die component, measured strain data, and detects a change in direction of the fluidic die component based on the measured strain data.

### BACKGROUND

A fluid dispensing system can dispense fluid towards a target. In some examples, a fluid dispensing system can include a printing system, such as a two-dimensional (2D) printing system or a three-dimensional (3D) printing system. A printing system can include printhead devices that include fluidic actuators to cause dispensing of printing fluids.

### BRIEF DESCRIPTION OF THE DRAWINGS

Some implementations of the present disclosure are described with respect to the following figures.

FIG. 1 is a block diagram of a fluid dispensing system according to some examples.

FIGS. 2 and 3 are block diagrams of fluidic dies for using in a fluid dispensing system according to various examples.

FIG. 4 is a graph of a curve representing strain amplitudes as a function of time, according to some examples.

FIG. 5 is a block diagram of an apparatus including a controller according to some examples.

FIG. 6 is a block diagram of a fluidic die component according to some examples.

FIG. 7 is flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A fluid dispensing device can include fluidic actuators that when activated cause dispensing (e.g., ejection or other flow) of a fluid. For example, the dispensing of the fluid can include ejection of fluid droplets by activated fluidic actuators from respective nozzles of the fluid dispensing device. In other examples, an activated fluidic actuator (such as a pump) can cause fluid to flow through a fluid conduit or fluid chamber. Activating a fluidic actuator to dispense fluid can thus refer to activating the fluidic actuator to eject fluid from a nozzle or activating the fluidic actuator to cause a flow of fluid through a flow structure, such as a flow conduit, a fluid chamber, and so forth.

Activating a fluidic actuator can also be referred to as firing the fluidic actuator. In some examples, the fluidic actuators include thermal-based fluidic actuators including heating elements, such as resistive heaters. When a heating element is activated, the heating element produces heat that can cause vaporization of a fluid to cause nucleation of a vapor bubble (e.g., a steam bubble) proximate the thermal-based fluidic actuator that in turn causes dispensing of a quantity of fluid, such as ejection from an orifice of a nozzle or flow through a fluid conduit or fluid chamber. In other examples, a fluidic actuator may be a piezoelectric membrane based fluidic actuator that when activated applies a mechanical force to dispense a quantity of fluid.

In examples where a fluid dispensing device includes nozzles, each nozzle includes a fluid chamber, also referred to as a firing chamber. In addition, a nozzle can include an orifice through which fluid is dispensed, a fluidic actuator, and possibly a sensor. Each fluid chamber provides the fluid to be dispensed by the respective nozzle.

Generally, a fluidic actuator can be an ejecting-type fluidic actuator to cause ejection of a fluid, such as through an orifice of a nozzle, or a non-ejecting-type fluidic actuator to cause flow of a fluid.

In some examples, a fluid dispensing device can be in the form of a fluidic die. A “die” refers to an assembly where various layers are formed onto a substrate to fabricate circuitry, fluid chambers, and fluid conduits. Multiple fluidic dies can be mounted or attached to a support structure. In other examples, a fluidic die can be in the form of a fluidic die sliver, which includes a thin substrate (e.g., having a thickness on the order of 650 micrometers (μm) or less) with a ratio of length to width (L/W) of at least three, for example. A die sliver can have other dimensions in other examples. Multiple fluidic die slivers can be molded into a monolithic molding structure, for example.

In the present disclosure, a “fluidic die component” can refer to either a fluidic die, or an electronic component that is part of, or attached to, or coupled to the fluidic die.

In some examples, a fluidic die can include a printhead die, which can be mounted to a print cartridge, a carriage assembly, and so forth. A printhead die includes nozzles through which a printing fluid (e.g., an ink, a liquid agent used in a 3D printing system, etc.) can be dispensed towards a target (e.g., a print medium such as a paper sheet, a transparency foil, a fabric, etc., or a print bed including 3D parts being formed by a 3D printing system to build a 3D object).

In some examples, the support structure to which a fluidic die can be mounted is movable. For example, in a printing system (2D printing system or a 3D printing system), the support structure includes a carriage assembly that can be moved along an axis, or along multiple axes.

It may be desirable to receive an indication that the carriage assembly or a mechanism driving movement of the carriage assembly is functioning properly, e.g., the carriage assembly is moving as expected (in the correct direction and to the correct position) based on control information from a system controller (in a fluid dispensing system); the timing of the movement of the carriage assembly matches the expected timing, to within a specified threshold, based on the control information from the system controller; and so forth. For example, a test can be performed in the fluid dispensing system to determine whether the following components are operating as expected: the carriage assembly, a motor that mechanically moves the carriage assembly, a motor controller that controls the motor, and so forth. The test can be used to determine whether a command to change direction of the carriage assembly issued by the system controller of the fluid dispensing system resulted in the corresponding change of direction of the carriage assembly.

As another example, the determination of whether the carriage assembly has changed directions can be used for determining whether a fluid dispensing system is operating in a target manner. If not (e.g., the carriage assembly did not change direction when the carriage assembly should have changed direction), then a fluid dispensing operation (e.g., a print operation) can be aborted or suspended.

In accordance with some implementations of the present disclosure, a controller receives, from a strain sensor (also referred to as a strain gauge) in a fluidic die, measured strain data, and detects a change in direction of the fluidic die based on the measured strain data. The controller can be a system controller in a fluid dispensing system, and the controller can be separate from the fluidic die. Alternatively, the controller can be part of the fluidic die.

As used here, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

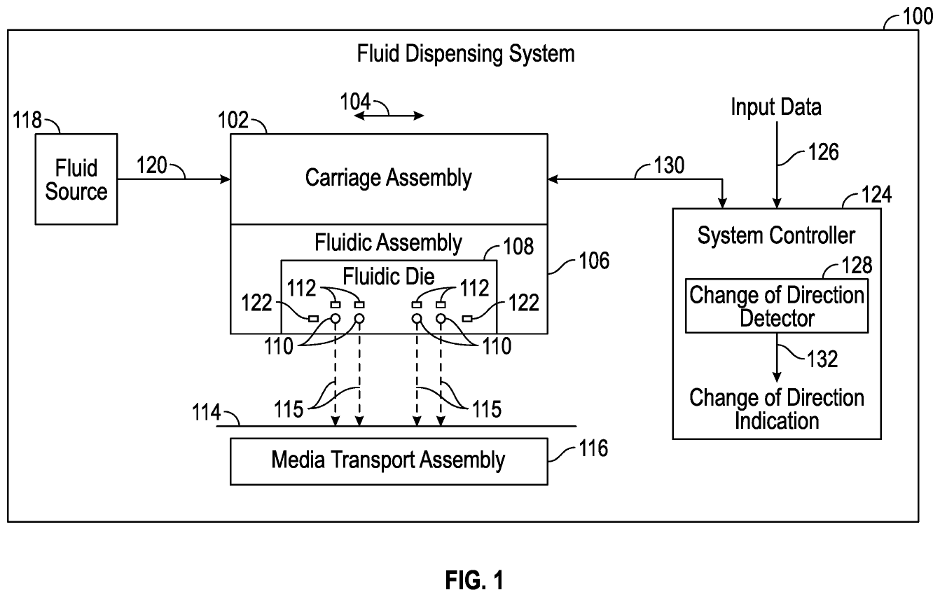

FIG. 1 is a block diagram of a fluid dispensing system 100 according to some examples. The fluid dispensing system 100 can be a printing system, such as a 2D printing system or a 3D printing system. In other examples, the fluid dispensing system 100 can be a different type of fluid dispensing system. Examples of other types of fluid dispensing systems include those used in fluid sensing systems, medical systems, vehicles, fluid flow control systems, and so forth.

The fluid dispensing system 100 includes a moveable carriage assembly 102 that is moveable along an axis 104. In further examples, the carriage assembly 102 is moveable along multiple axes. A “carriage assembly” can refer to any support structure to which a fluidic assembly 106 can be mounted. In some examples, the fluidic assembly 106 is fixedly mounted to the carriage assembly 102. In other examples, the fluidic assembly 106 is removably mounted to the carriage assembly 102. In the latter examples, the fluid dispensing system 100 can be delivered to a customer without the fluidic assembly 106 attached to the carriage assembly 102. At the customer site, the customer can attach the fluidic assembly 106 to the carriage assembly 102. In other examples, the customer can replace an existing fluidic assembly 106 with a new fluidic assembly 106.

A “fluidic assembly” can be in the form of a cartridge (e.g., a print cartridge), a pen (e.g., an ink pen), a print bar, or any other structure that holds a fluidic die 108 (or multiple fluidic dies).

The fluidic die 108 includes orifices 110 through which fluid can be dispensed to a target medium 114 (e.g., a print medium) in response to activation of respective fluidic actuators 112. In a 2D printing system, the target medium 114 can include a paper, a fabric, a transparency foil, and so forth. In a 3D printing system, the target medium 114 can include a build bed including a 3D part (or multiple 3D parts) of a 3D object built by the 3D printing system on a layer-by-layer basis.

The target medium 114 can be transported by a media transport assembly 116. For example, the media transport assembly 116 can include rollers to move the target medium 114 to a target zone (e.g., a print zone of a printing system). Once the target medium 114 is in the target zone, the fluidic die 108 can be controlled to dispense fluid onto the target medium 114.

As the fluidic assembly 106 and the target medium 114 are moved relative to one another (due to movement of the carriage assembly 102 and/or the target medium 114), selected fluidic actuators 112 can be activated to cause dispensing of fluid droplets 115 from respective orifices 110 onto target portions of the target medium 114.

A fluid source 118 (e.g., a fluid reservoir, a fluid tank, etc.) provides fluid 120 to the fluidic assembly 106 through the carriage assembly 102. The fluid is transported through a fluid conduit (or multiple fluid conduits) to the carriage assembly 102, which includes internal fluid paths to the fluidic assembly 106.

Although FIG. 1 shows the fluid source 118 as being separate from the fluidic assembly 106, it is noted that in other examples, the fluid source 118 can be part of the fluidic assembly 106.

The fluidic die 108 includes strain sensors 122. Although FIG. 1 shows the fluidic die 108 having two strain sensors 122, it is noted that in other examples, the fluidic die 108 can include just one strain sensor 122 or more than two strain sensors 122.

Each strain sensor 122 senses strain within the fluidic die 108. The strain sensor 122 exhibits changes in electrical conductivity and/or another property (e.g., voltage, inductance, capacitance, etc.) when corresponding portions of the fluidic die 108 are strained, such as due to movement of the carriage assembly 102, and especially during a change in direction of the carriage assembly 102 as the carriage assembly moves back and forth in different directions along the axis 104. The amount of strain experienced by the fluidic die 108 is quantified by measuring changes in conductivity of the strain sensor 122. In such examples, the measured conductivity of the strain sensor 122 is part of the measured strain data from the strain sensor 122.

The fluid dispensing system 100 includes a system controller 124 that is able to control operations of the fluid dispensing system 100, including fluid dispensing operations based on activation of fluidic actuators 112 to cause dispensing of fluid through orifices 110 of the fluidic die 108 to the target medium 114.

The system controller 124 can control the operations of the fluid dispensing system 100 based on input data 126, which can be received from a computer that is directly connected to the fluid dispensing system 100 or connected over a network to the fluid dispensing system 100. For example, the input data can include print data representing text and/or images to be printed onto the target medium 114, or a digital representation of a 3D object to be built.

In some examples, the system controller 124 includes a change of direction detector 128 according to some implementations of the present disclosure. The change of direction detector 128 can be implemented as a portion of the hardware processing circuit of the system controller 124, or alternatively, the change of direction detector 128 can be implemented as machine-readable instructions executable by the system controller 124.

In other examples, the change of direction detector 128 can be part of a controller that is separate from the system controller 124. In further examples, the change of direction detector 128 can be part of a controller in the fluidic die 108.

The system controller 124 communicates over a communication link 130 (e.g., wired link or a wireless link) with the carriage assembly 102. The carriage assembly 102 includes communication paths (e.g., electrically conductive wires or traces or optical links) to communicate with the fluidic die 108 and more particularly, with the strain sensors 122 in the fluidic die 108.

In examples where the change of direction detector 128 is part of the system controller 124, the change of direction detector 128 receives measured strain data from the strain sensors 122 over the communication link 130, and makes a determination of whether the carriage assembly 102 has changed directions, such as during a carriage assembly return in which the carriage assembly 102 scans along a first direction, and when the carriage assembly 102 reaches the end of the scan, reverses direction and scans backward in the opposite direction.

In response to detecting a change in direction of the carriage assembly 102, the change of direction detector 128 outputs a change of direction indication 132. The change of direction indication 132 can be used by the system controller 124 for any of various purposes, such as to perform a test of the carriage assembly 102 and the mechanism that drives movement of the carriage assembly 102. In further examples, the change of direction indication 132 can be output by the change of direction detector 128 to another component in the fluid dispensing system 100, or to an entity (e.g., a computer, a program, a user, etc.) that is external of the fluid dispensing system 100.

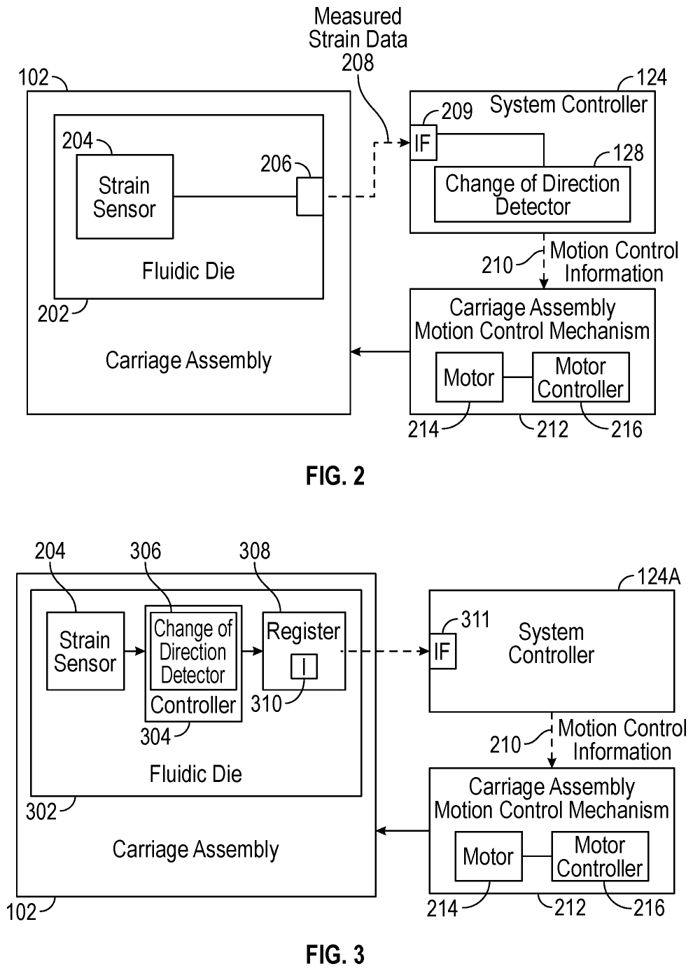

FIG. 2 is a block diagram of an example arrangement that includes a fluidic die 202 mounted to the carriage assembly 102. FIG. 2 also shows the system controller 124 that includes the change of direction detector 128.

The fluidic die 202 includes a strain sensor 204. In other examples, the fluidic die 202 can include more than one strain sensor 204.

The output of the strain sensor 204 is coupled to an electrical contact 206, such as a bond pad or other electrically conductive structure. Although not shown, in some examples, signal processing circuitry can be provided between the output of the strain sensor 204 and the electrical contact 206. The signal processing circuitry can include, for example, any or some combination of the following: an amplifier to amplify a signal of the strain sensor 204, a filter to filter a signal of the strain sensor 204, and so forth.

More generally, the fluidic die 202 includes a communication interface that allows strain data 208 measured by the strain sensor 204 to be communicated off the fluidic die 202 to a component (e.g., the system controller 124) that is external of the fluidic die 202. If the signal processing circuitry is present, the strain data 208 measured by the strain sensor 204 refers to data that has been subjected to the signal processing (e.g., amplification, filtering, etc.).

The measured strain data 208 is communicated from the strain sensor 204 through the electrical contact 206 and an electrical path of the carriage assembly 102, and over a communication link (e.g., 130 in FIG. 1) to the system controller 124. The measured strain data 208 is received by a communication interface 209 of the system controller 124. The communication interface 209 can include an electrical contact, a connector, or any other connection structure.

The measured strain data 208 can be processed by the change of direction detector 128 to determine whether the fluidic die 202 has experienced a change of direction.

As further shown in FIG. 2, the system controller 124 can output motion control information 210 (including any of signals, commands, messages, etc.) to a carriage assembly motion control mechanism 212. For example, the carriage assembly motion control mechanism 212 can include a motor 214 and a motion controller 216 to control the motor 214 in response to the motion control information 210. The carriage assembly motion control mechanism 212 can control movement of the carriage assembly 102 according to the motion control information 210.

FIG. 3 is a block diagram of an example arrangement that includes a fluidic die 302 mounted to the carriage assembly 102. FIG. 2 also shows a system controller 124A that does not include the change of direction detector 128. In the example of FIG. 3, the fluidic die 302 includes the strain sensor 204, and a controller 304 that includes a change of direction detector 306 that performs a change of direction detection of the carriage assembly 102 based on measured strain data from the strain sensor 204.

The change of direction detector 306 determines whether the fluidic die 302 has experienced a change of direction based on the measured strain data.

The change of direction detector 306 can store an indicator 310 in a register 308, for indicating whether or not the fluidic die 302 has experienced a change of direction. More generally, the indicator can be stored in a storage of the fluidic die 302. For example, storage can be in the form of a non-volatile memory or volatile memory in the fluidic die 302.

The indicator 310 can include a flag, which includes a bit or multiple bits. The indicator 310 if set to a first value indicates that the fluidic die 302 has experienced a change of direction. The indicator if set to a different second value indicates that the fluidic die 302 has not changed direction.

In some examples, multiple instances of the indicator 310 can be stored in the register 308. In such examples, the multiple instances of the indicator 310 can be associated with respective timestamps, to indicate times at which the fluidic die 302 has (or has not) changed directions.

The system controller 124A can read the indicator(s) 310 from the register 308, to determine whether a change of direction of the fluidic die 302 has occurred. The system controller 124A can read the indicator(s) 310 from the register 308 as part of a test of the fluid dispensing system, or as part of verifying that the fluid dispensing system is operating in a target manner.

The indicator(s) 310 is (are) received by a communication interface 311 of the system controller 124A. The communication interface 311 can include an electrical contact, a connector, or any other connection structure.

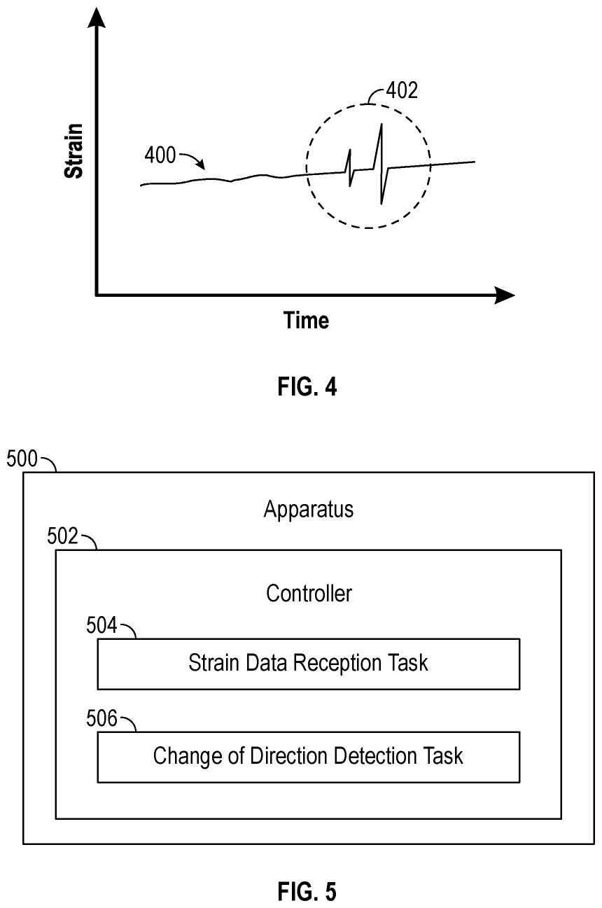

The change of direction detector 128 or 306 can compare the measured strain data (at a single point in time or at multiple time points) from a strain sensor (or from multiple strain sensors) to a specified strain data profile, such as shown in FIG. 4.

FIG. 4 shows a graph 400 that represents amplitudes of measured strain (vertical axis) at different time points (horizontal axis). A portion 402 of the graph 400 represents a strain profile indicating changes in strain amplitudes over time that are indicative of a change in direction of the carriage assembly 102.

The change of direction detector 128 or 306 can compare strain data collected at multiple time points from the strain sensor to the specified strain data profile, and if the strain data collected at multiple time points from the strain sensor matches the specified strain data profile (to within some specified tolerance), the change of direction detector 128 or 306 outputs an indication to indicate a change of direction of the fluidic die.

FIG. 5 is a block diagram of an apparatus 500 that includes a controller 502. The apparatus 500 can include a fluidic die (e.g., 302 in FIG. 3), or a system controller (e.g., 124 in FIG. 1 or 2), or any other device or component.

The controller 502 can perform change of direction determination tasks according to some examples. The change of direction determination tasks include a strain data reception task 504 to receive, from a strain sensor in a fluidic die component, measured strain data. The change of direction determination tasks further include a change of direction detection task 506 to detect a change in direction of the fluidic die component based on the measured strain data.

In some examples, the controller 502 is to determine whether the measured strain data has a specified amplitude profile (e.g., the profile represented by the graph portion 402 in FIG. 4) to detect the change in direction of the fluidic die component.

In some example, the controller 502 is separate from the fluidic die component. The controller 502 is receive the measured strain data from the strain sensor through a communication interface of the fluidic die component.

In further examples, the controller 502 is part of the fluidic die component. In such examples, the apparatus 500 further includes a storage (e.g., 308 in FIG. 3) to store an indicator set by the controller 502, the indicator settable to a first value to indicate occurrence of the change in direction of the fluidic die component.

In some examples, the controller 502 is to issue motion control information to cause a change of direction of a support structure to which the fluidic die component is mounted, and verify operation of the support structure based on the detection of the change in direction of the fluidic die component based on the measured strain data.

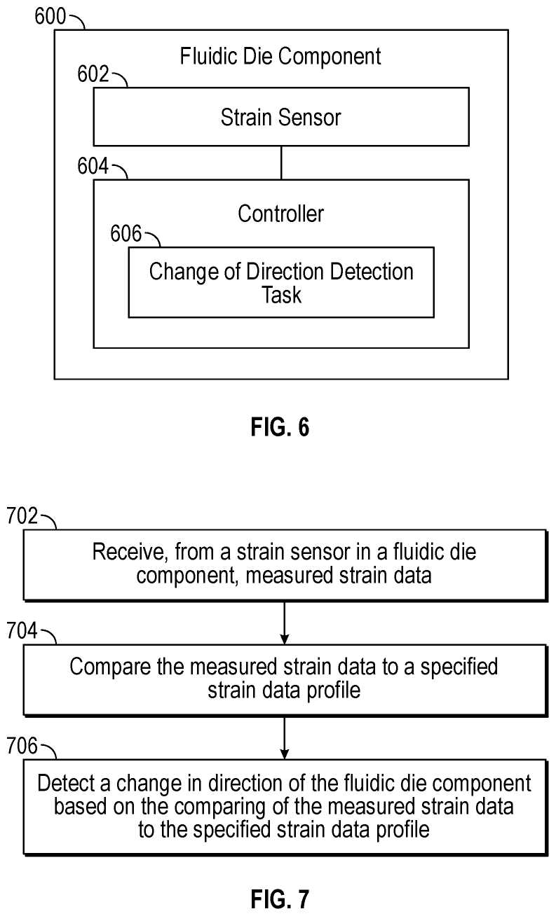

FIG. 6 is a block diagram of a fluidic die component 600 that includes a strain sensor 602 and a controller 604 to perform a change of direction detection task 606 to detect a change in direction of a support structure to which the fluidic die component is mounted based on measured strain data from the strain sensor 602.

FIG. 7 is a flow diagram of a process of a controller (e.g., 124 in FIG. 1 or 2 or 304 in FIG. 3). The controller receives (at 702), from a strain sensor in a fluidic die component, measured strain data.

The controller compares (at 704) the measured strain data to a specified strain data profile.

The controller detects (at 706) a change in direction of the fluidic die component based on the comparing of the measured strain data to the specified strain data profile.

In some examples, the measured strain data includes a plurality of measured strain data samples acquired at different times or from multiple strain sensors in the fluidic die component.

In examples where machine-readable instructions are provided to perform change of direction detection tasks according to some examples of the present disclosure, the machine-readable instructions can be stored in a non-transitory machine-readable or computer-readable storage medium.

The storage medium can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
a controller to:
receive, from a strain sensor in a fluidic die component, measured strain data; and
detect a change in direction of the fluidic die component based on the measured strain data.

2. The apparatus of claim 1, wherein the controller is separate from the fluidic die component.

3. The apparatus of claim 2, wherein the controller is to receive the measured strain data from the strain sensor through a communication interface of the fluidic die component.

4. The apparatus of claim 3, further comprising a moveable carriage assembly to which the fluidic die component is mountable, wherein the controller is to receive the measured strain data from the strain sensor through the carriage assembly and the communication interface.

5. The apparatus of claim 1, wherein the controller is part of the fluidic die component.

6. The apparatus of claim 3, further comprising a storage to store an indicator set by the controller, the indicator settable to a first value to indicate occurrence of the change in direction of the fluidic die component.

7. The apparatus of claim 1, wherein the controller is to determine whether the measured strain data has a specified amplitude profile to detect the change in direction of the fluidic die component.

8. The apparatus of claim 1, wherein the controller is to:
issue motion control information to cause a change of direction of a support structure to which the fluidic die component is mounted; and
verify operation of the support structure based on detection of the change in direction of the fluidic die component based on the measured strain data.

9. A fluidic die component comprising:
a strain sensor; and
a controller to:
detect a change in direction of a support structure to which the fluidic die component is mounted based on measured strain data from the strain sensor.

10. The fluidic die component of claim 9, further comprising:
a storage to store an indicator settable to a first value for indicating the change in direction.

11. The fluidic die component of claim 10, further comprising:
a communication interface to communicate with a system controller that is external of the fluidic die component,
wherein the storage is accessible through the communication interface.

12. The fluidic die component of claim 10, wherein the controller is to:
set the indicator in the storage to the first value in response to detecting the change in direction of the support structure based on the measured strain data from the strain sensor, and
set the indicator in the storage to a different second value in response to not detecting the change in direction of the support structure based on the measured strain data from the strain sensor.

13. The fluidic die component of claim 9, further comprising:
an orifice; and
a fluidic actuator activatable to dispense a fluid through the orifice.

14. A method comprising:
receiving, from a strain sensor in a fluidic die component, measured strain data;
comparing the measured strain data to a specified strain data profile; and
detecting a change in direction of the fluidic die component based on the comparing of the measured strain data to the specified strain data profile.

15. The method of claim 14, wherein the measured strain data comprises a plurality of measured strain data samples acquired at different times or from multiple strain sensors in the fluidic die component.
